(19) United States
(12) Patent Application Publication
(10) Pub. No.: US 2016/0021341 A1
(43) Pub. Date: Jan. 21, 2016

(54) IMAGE-CAPTURING MECHANISM AND ELECTRONIC DEVICE HAVING THE SAME

(71) Applicants: LITE-ON ELECTRONICS (GUANGZHOU) LIMITED, GUANGZHOU (CN); LITE-ON TECHNOLOGY CORPORATION, TAIPEI CITY (TW)

(72) Inventors: LI-HSIN LEE, TAIPEI CITY (TW); TZU-CHIEN WANG, TAINAN CITY (TW)

(21) Appl. No.: 14/671,093

(22) Filed: Mar. 27, 2015

(30) Foreign Application Priority Data
Jul. 18, 2014 (CN) 201410344785.4

(51) Int. Cl. H04N 7/18; H04N 5/225; G03B 15/05

(52) U.S. Cl. CPC H04N 7/18; G03B 15/05; H04N 5/2254

(57) ABSTRACT

An electronic device with image-capture mechanism has a housing and an image-capture mechanism. The image-capture mechanism has a positioning bracket, a camera module, at least one resilient element and adjustable element. The housing has a front casing including a viewable hole arranged thereon and a rear casing. The positioning bracket has a pair of pivotable portions and a lens portion arranged between the pivotable portions and in the viewable hole. The camera module has a carrier plate, a pair of pivotable pins, and a camera fixed on the carrier plate. The pivotable pins pivotally connect to the pivotable portions. The camera is configured to correspond to the lens portion. The resilient element has two ends respectively abutting the positioning bracket and the carrier plate. The adjustable element abuts the carrier plate for the adjustment of a relative angle between the carrier plate and the positioning bracket.

### BACKGROUND OF THE INVENTION

1. Field of the Invention

The invention relates to an electronic device, more particularly to an image-capturing mechanism and an electronic apparatus having the same.

2. Description of Related Art

A video intercom system is embedded within the walls of the first floor of an aesthetically pleasing yet space limiting city building where many tenants reside, and the front camera lens is fixed on a bracket that is further fixed on the system. The overall design typically involves the main unit to be entirely indented into the walls. As a result the image-capturing system is limited to only front viewing but impossible to adjust the image-capturing angle. If columns are design in front of the doors of an architecture or if an open area is obstructed from view (such as turning walls), the image-capturing range of the conventional video intercom system is reduced due to the assembled location thereof, which renders image-capturing difficult, limits the viewable range from left and right angle adjustments, and affects the viewable range of the camera.

### SUMMARY OF THE INVENTION

The objective of the instant disclosure is to provide an electronic device having an angle adjustable image-capturing mechanism that is not limited to the assembled location thereof.

Another objective of the instant disclosure is to provide an electronic device having an angle adjustable image-capturing mechanism, which includes an angle adjustable image-capturing mechanism that can adjust the angle of the camera due to the limitations of the assembled location, so that even if the electronic device is installed in a recess or the view path is blocked by objects, the viewable range is not obstructed.

In order to achieve the aforementioned objectives, according to an embodiment of the instant disclosure, an image-capturing mechanism for mounting on an electronic device, comprising:

a positioning bracket having a pivotable portion and a lens portion arranged on opposite surfaces of the positioning bracket;

a camera module including a carrier plate, a pivotable pin arranged on the carrier plate, and a camera arranged on the carrier plate;

at least one resilient element having two ends, wherein the two ends are respectively configured to correspond to the translucent portions the positioning bracket and the carrier plate; and

at least one adjustable element, the adjustable element having an end corresponding to a surface of the carrier plate opposite the camera for adjustment of the carrier plate, and an image-capturing angle of the camera module.

In order to achieve the aforementioned objectives, according to an embodiment of the instant disclosure, an electronic device having an angle adjustable image-capturing mechanism is provided, comprising:

a housing including a front casing and a rear casing mutually engaging with the front casing, wherein the front casing has a viewable hole arranged thereon;

a positioning bracket having a pivotable portion and a lens portion arranged on opposite surfaces of the positioning bracket, wherein the lens portion corresponds to the viewable hole;

a camera module including a carrier plate, a pivotable pin arranged on the carrier plate, and a camera arranged on the carrier plate, wherein the pivotable pin is pivotably coupled to the pivotable portion, and the camera corresponds to the lens portion;

at least one resilient element having two ends, wherein the two ends are respectively configured to correspond to the positioning bracket and the carrier plate; and

at least one adjustable element, the adjustable element having an end corresponding to the carrier plate for adjustment of the carrier plate, and an image-capturing angle of the camera module.

The instant disclosure is able to adjust the angle of the image-capturing mechanism so that it is not limited to the assembled location thereof. Moreover, with the structural design that provides minimized rotational space, the image-capturing mechanism can be assembled in indentations or places where the viewable range is blocked by obstructions by rotating the camera angle to move away from the obstruction that immediately enhances the viewable range.

In order to further understand the instant disclosure, the following embodiments and illustrations are provided. However, the detailed description and drawings are merely illustrative of the disclosure, rather than limiting the scope being defined by the appended claims and equivalents thereof.

### BRIEF DESCRIPTION OF THE DRAWINGS

FIG. 1 is an exploded view of an electronic device having an image-capturing mechanism in accordance with the instant disclosure;

FIG. 2 is another exploded view of the electronic device having an image-capturing mechanism in FIG. 1 in accordance with the instant disclosure;

FIG. 3 is an exploded view of the image-capturing mechanism in FIG. 2 in accordance with the instant disclosure;

FIG. 4 is another exploded view of the image-capturing mechanism in FIG. 2 in accordance with the instant disclosure;

FIG. 5 a partial assembled view of the image-capturing mechanism in FIG. 2 in accordance with the instant disclosure;

FIG. 6 is an assembled view of the electronic device having an image-capturing mechanism in accordance with the instant disclosure;

FIG. 7 is another exploded view of the electronic device having an image-capturing mechanism in accordance with the instant disclosure;

FIG. 8 is a cross-sectional view of FIG. 7 along the line A-A before adjustments in accordance with the instant disclosure; and

FIG. 9 is a cross-sectional view of FIG. 7 along the line A-A after adjustments in accordance with the instant disclosure.

### DETAILED DESCRIPTION OF THE PREFERRED EMBODIMENTS

The aforementioned illustrations and detailed descriptions are exemplarities for the purpose of further explaining the scope of the instant disclosure. Other objectives and advantages related to the instant disclosure will be illustrated in the subsequent descriptions and appended drawings.

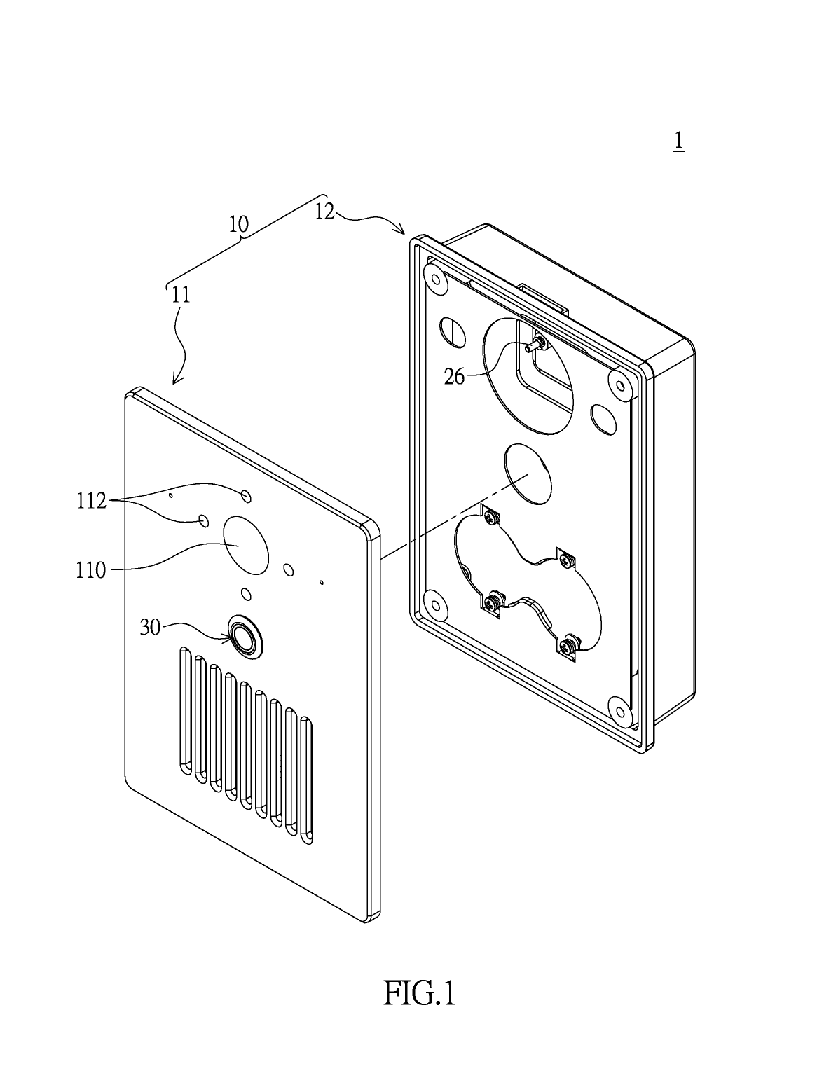

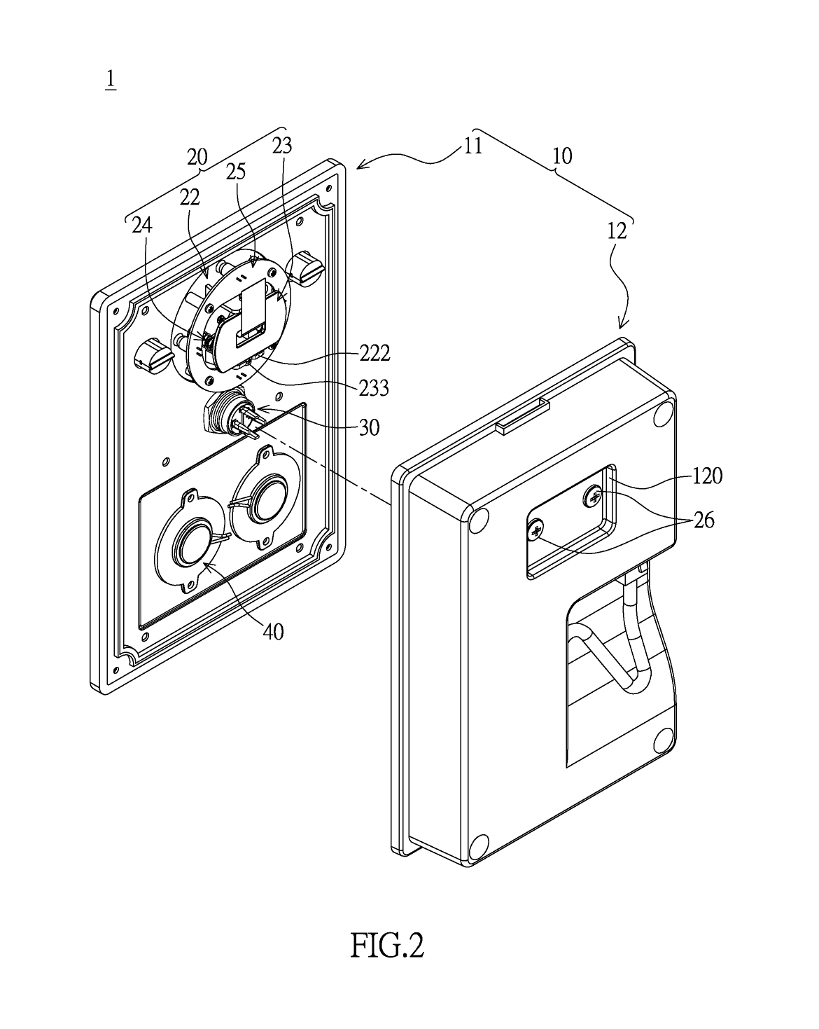

Referring to FIGS. 1 and 2, an electronic device is exemplified as an outdoor video intercom system in the instant embodiment. The electronic device 1 includes a housing 10, an angle adjustable image-capturing mechanism 20, a button 30, and a speaker unit 40.

The housing 10 includes a front casing 11 and a rear casing 12 mutually engaged to assemble with the front casing 11. The front casing 11 has a viewable hole 110 arranged thereon, and a plurality of lighting holes 112 peripherally arranged around the viewable holes 110.

As shown in FIG. 2, the angle adjustable image-capturing mechanism 20 is also called image-capturing mechanism 20 hereinafter for short. The image-capturing mechanism 20 is arranged in the housing 10 at an inner surface of the front casing 11. The image-capturing mechanism 20 includes a positioning bracket 22, a camera module 23, a resilient element 24, and a lighting unit 25, as well as an adjustable element 26 passes through the rear casing 13 and abuts the camera module 23 in order to adjust the image-capturing angle of the camera module 23.

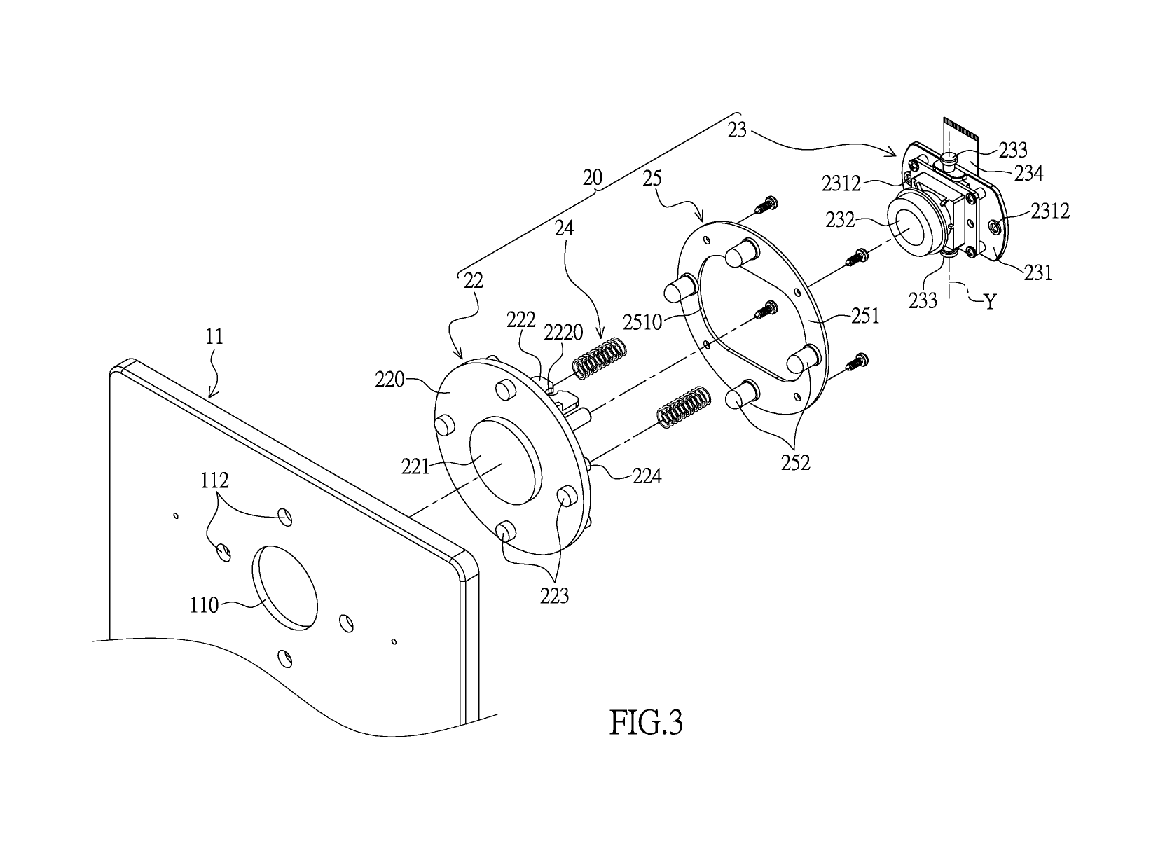

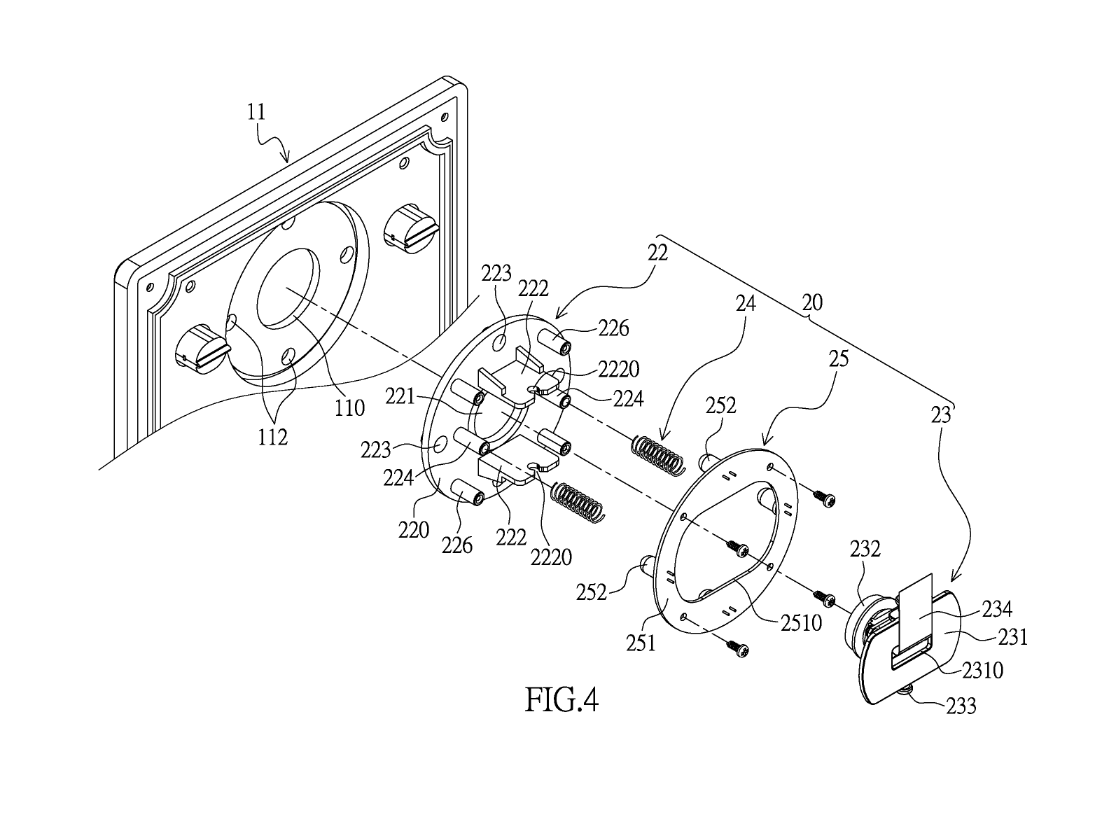

With further reference to FIGS. 3 and 4, the positioning bracket 22 includes a circular body 220, a pivotable portion 222 arranged on a surface of the positioning bracket, a lens portion 221 coupled to the body 220, and a plurality of translucent portions 223 peripherally arranged around the lens portion 221. The quantity of the pivotable portion 222 is preferably a pair in this embodiment. The lens portion 221 is configured between the pair of pivotable portions 222 in the instant embodiment and is made of transparent materials, such that the camera module 23 can directly capture images. The lens portion 221 resembles a plate shape and has a indentation thereon as shown in FIG. 4. The lens portion 221 and the translucent portion 223 each have portions protruding from a front surface of the positioning bracket 22, and the protruding portions of each respectively engage to the viewable hole 110 and the lighting hole 112 of the front casing 11. The pivotable portion 222 resembles a plate shape that protrudes from the inner surface of the body 220. The pivotable portion 222 also has a concaved pivot hole 2220 arranged thereon. The positioning bracket 22 is preferably integrally formed by double injection molding while transparent materials form the lens portion 221 and the translucent portion 223, the non-transparent materials form the discoid shaped body 220. The body 220 is also integrally formed with the pivotable portion 222 to provide a pivot point for the image-capturing mechanism 20.

The camera module 23 includes a carrier plate 231, a pivotable pin 233 connected to the carrier plate 231, and a camera 232 fixed on the carrier plate 231. A pair of pivotable pins 233 is pivotably coupled to the pivotable portion 222. The camera 232 is aligned with the lens portion 221 in order to capture images through the lens portion 221. The pair of pivotable pins 233 is respectively arranged on two opposite surfaces of the carrier plate 231 and is aligned along a center axis Y. The center axis Y is substantially parallel to an inner surface of the positioning bracket 22 and normal to an optical axis of the camera 232. The center axis Y of the instant embodiment is parallel to a longitudinal direction of the housing 10, such that the camera module 23 can rotate about the center axis Y on the positioning bracket 22 in order to adjust the image-capturing angle of the camera 232. For example, as shown in FIG. 3, to adjust the camera 232 towards the left side or the right side of the front casing 11. The typical image capturing height of the camera 232 can be determined according to the facility on which it is installed and deemed appropriate without having to adjust the image-capturing angle of the camera 232. However, if objects, such as columns or corner walls, obstructs the line of sight of the image-capturing mechanism on a facility, the camera 232 of the instant embodiment can be adjusted so that the image-capturing angle can be adjust to the left or right in order to avoid the object. However, the instant disclosure does not limit the center axis's extending direction, the center axis can be normal to the longitudinal direction of the housing 10, such as the horizontal direction in FIG. 3, such that the image-capturing angle can also be adjusted vertically with respect FIG. 3.

As shown in FIG. 4, the carrier plate 231 has a cable opening 2310, in which the camera 232 has a cable 234 that passes through the cable opening 2310.

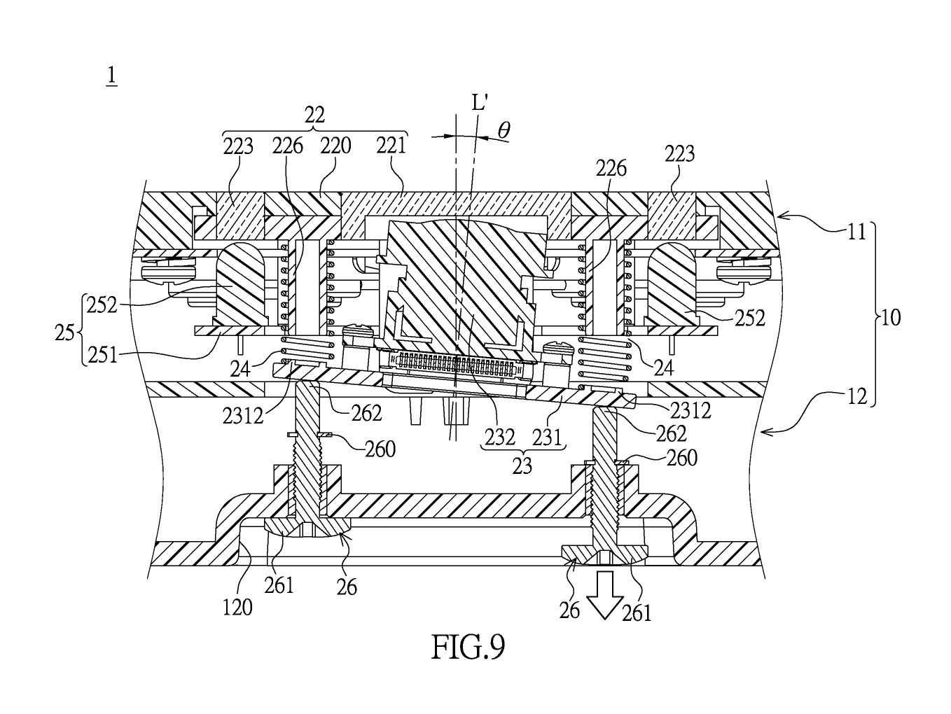

As shown in FIGS. 3 and 4, the resilient element 24 of the instant embodiment has two ends respectively abut the positioning bracket 22 and the carrier plate 231. A pair of resilience elements 24 can be compressible springs. The inner surface of the positioning bracket 22 has a pair of first mounting portions 224 to fix the springs. The carrier plate 231 has a pair of second mounting portions 2312 respectively arranged on two sides of the center axis Y. The compressible spring has two ends which respectively fix the first mounting portion 224 and the second mounting portion 2312, in which the camera module 23 is pushed towards the rear casing 12 by the compressible spring at normal conditions. Thus, the pair of pivotable pins 233 resembles a linked rod, while the second mounting portions 2312 resemble two nodes. When one of the nodes is fixed (compressible spring exerting corresponding pressure) while the other compressible spring expands, the camera module 23 is subsequently rotated with a predetermined trajectory (as shown in FIG. 9).

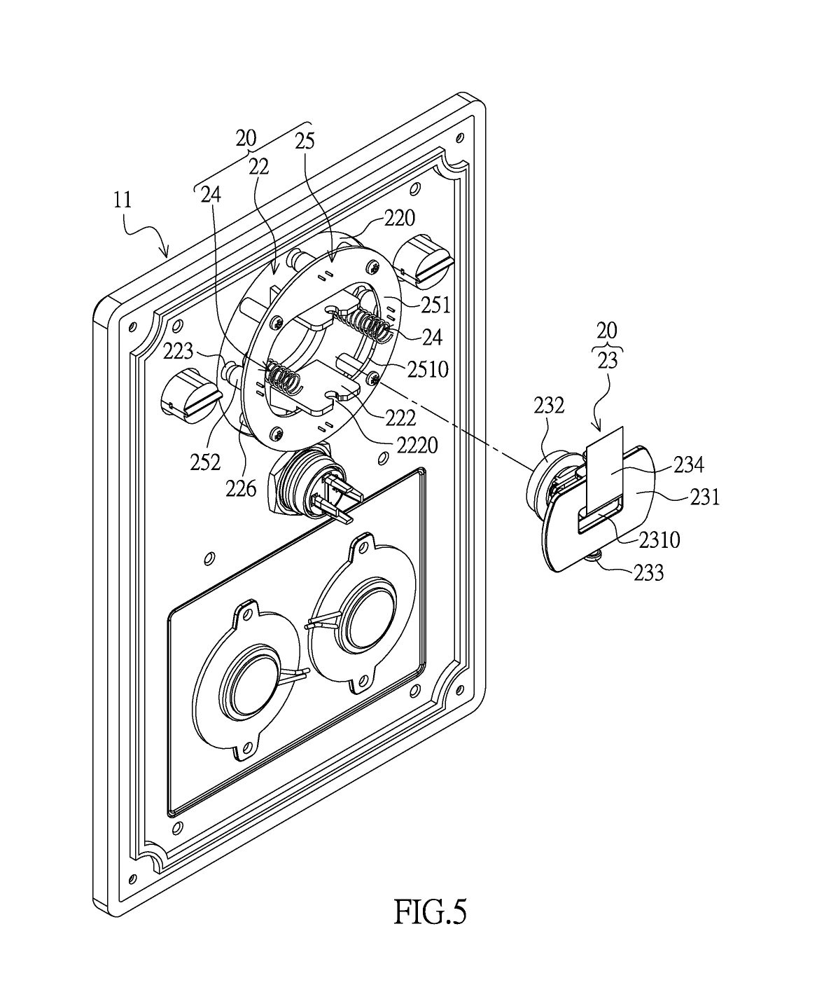

As shown in FIGS. 3 and 5, the lighting unit 25 of the instant embodiment can provide supplemental lighting. The lighting unit 25 has a circuit board 251 fixed on the positioning bracket 22, and a plurality of light sources 252 disposed on the circuit board 251. The light sources 252 are LED lights in the instant embodiment, which are arranged around the camera 232 and are respectively configured to correspond to the translucent portions 223 of the positioning bracket 22. The quantity of light sources 252 is not limited to the examples provided therein. The circuit board 251 has a mounting hole 2510 arranged thereon. The pair of pivotable portions 222 pass through the mounting hole 2510 while the camera module 23 is arranged in the mounting hole 2510.

As shown in FIG. 5, the lighting unit 25 of the instant embodiment is assembled on the positioning bracket 22. The circuit board 25 is screwed and locked onto a fixing post 226 of the positioning bracket 22. Moreover, the camera module 23 can be assembled to the positioning bracket 22, that is, the pivotable pins 233 are respectively coupled, clicked or snapped into pivot holes 2220 of the pair of pivotable portions 222 (as shown in FIG. 2).

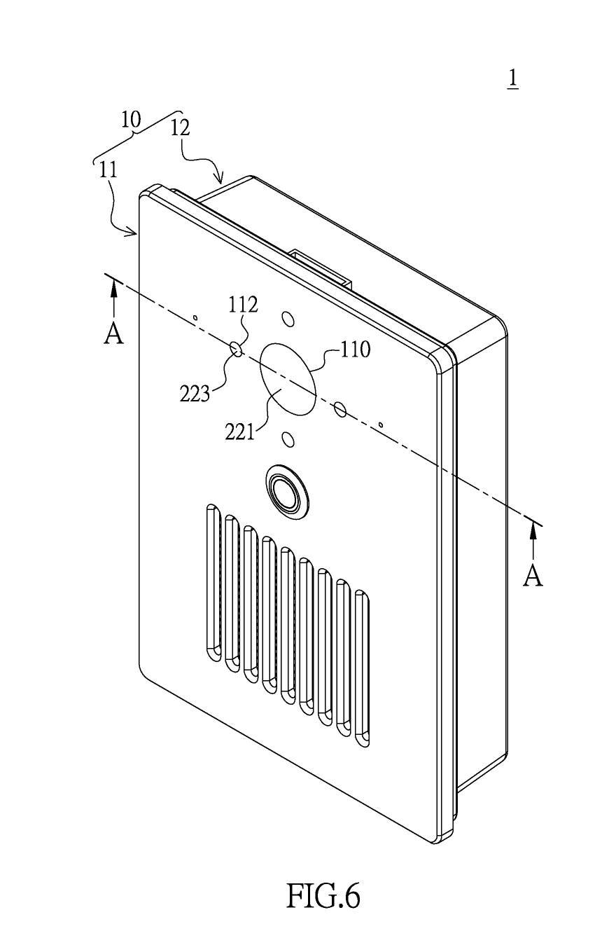

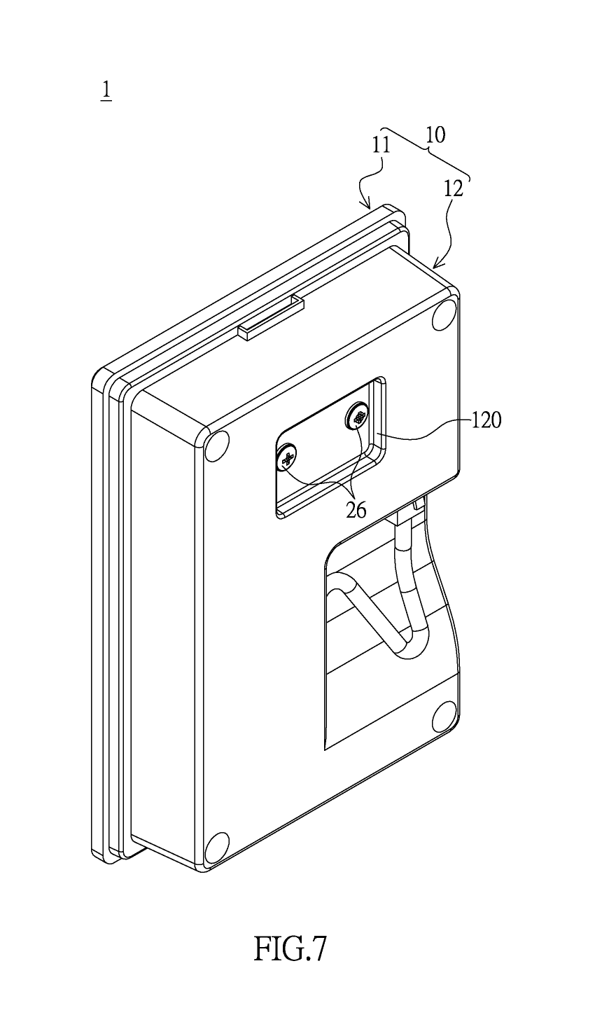

As shown in FIGS. 6 to 8, rotation of the image-capturing angle of the positioning bracket 22 is adjusted by manipulating the adjustable element 26 to pass through the rear casing 12 and abut the carrier plate 231, then subsequently adjust the relative angle between the carrier plate 231 and the positioning bracket 22. There can be one or a pair of adjustable elements 26, but a pair of adjustable elements 26 is provided in the instant embodiment. Screws for example are used as the adjustable elements 26. Each adjustable element 26 has a head portion 261. The rear casing 12 has a indentation 120 arranged thereon. The adjustable elements 26 pass through the indentation 120 and the head portions 261 are exposed from the rear casing 12 to facilitate screwing the adjustable element 26. The adjustable element 26 also has a free end 262 that abuts a position on a surface of the carrier plate 231 and is configured to correspond to the second mounting portion 2312, notably correspond to the resilient element 24. In other words, the head portions 261 can be screwed or rotated to adjust the free end 262 to displace towards the front casing 11 or the rear casing 12. The adjustable element 26 also has an stop member 260 arranged in the housing 10 to prevent the adjustable element 26 from excessive outward rotation. As shown in FIG. 7, the optical axis L of the camera 232 is normal to the housing 10 before adjustments.

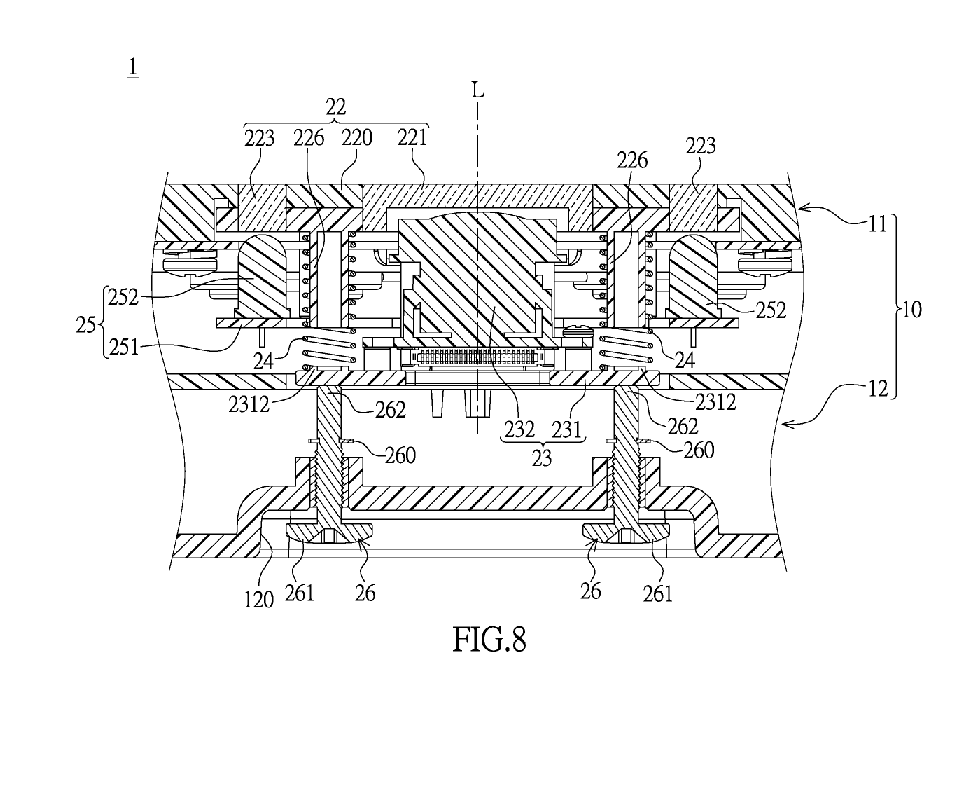

As shown in FIG. 8, the resilient member 24 is in a compressed state which pushes against the carrier plate 231 of the camera module 23 and maintains two sides of the carrier plate 231 to push against the pair of adjustable elements 26. As shown in FIG. 9, when the image-capturing angle is adjusted, the head portion 261 of the adjustable element 26 is rotated through the indentation 120 of the rear casing 12 in the instant embodiment. As the right adjustable element 26 is rotated outwardly, the stop member 260 is stopped inside the rear casing 12 where the indentation 120 is, and resilient member 24 on the right side corresponding to the right adjustable element 26 is in an expansion state to push against the right side of the carrier plate 231 to rotate. After the rotation, the optical axis L′ of the camera 232 is tilted towards the right such that the image-capturing angle is adjusted towards the right. The lens portion 221 resembles a discoid shape and has a groove that provides buffer space for the camera 232 as it rotates. Moreover, only one adjustable element 26 can be provided as well in the instant embodiment to provide immediate adjustment to the image-capturing angle of the camera module 23.

The angle adjustable image-capturing mechanism of the instant disclosure can be displaced for adjustment and is not limited to the assembled location thereof. Moreover, the adjustable element 26 is arranged towards the rear of the housing 10, so that the image-capturing mechanism can be hidden in walls after adjustments without affecting the physical appearance of the electronic devices, as well as minimizes the rotational space required. By rotating, the camera angle is immediately adjusted to enhance viewable range. Furthermore, the overall thickness of the angle adjustable image-capturing mechanism in the instant disclosure is substantially identical to a length of the camera 232, which only increases the thickness of the carrier plate 231 and the pivotable pin 233 in comparison to the traditional fixed camera but not the overall thickness of the electronic device.

The figures and descriptions supra set forth illustrate the preferred embodiments of the instant disclosure; however, the characteristics of the instant disclosure are by no means restricted thereto. All changes, alterations, combinations or modifications conveniently considered by those skilled in the art are deemed to be encompassed within the scope of the instant disclosure delineated by the following claims.

What is claimed is:

1. An image-capturing mechanism for mounting on an electronic device, said image-capturing mechanism comprising:
a positioning bracket including a pivotable portion and a lens portion arranged on opposite surfaces of the positioning bracket;
a camera module including a carrier plate, a pivotable pin arranged on the carrier plate, and a camera arranged on the carrier plate;
at least one resilient element having two ends, wherein the two ends are respectively configured to correspond to the translucent portions the positioning bracket and the carrier plate; and
at least one adjustable element, the adjustable element having an end corresponding to a surface of the carrier plate opposite the camera for adjustment of the carrier plate, and an image-capturing angle of the camera module.

2. The image-capturing mechanism as claimed in claim 1, further comprising:
a lighting unit having a circuit board fixed on the positioning bracket, and a plurality of light sources disposed on the circuit board and peripherally arranged about the camera, wherein the circuit board has a plurality of mounting holes arranged thereon, wherein the pivotable portion passes through the mounting hole, and the camera module is arranged in the mounting hole.

3. The image-capturing mechanism as claimed in claim 2, wherein the positioning bracket has a plurality of translucent portions integrally formed by double injection molding, the light sources are respectively configured to correspond to the translucent portions, and the lens portion are integrally formed with the positioning bracket via double injection molding.

4. The image-capturing mechanism as claimed in claim 1, wherein the pivotable pin is arranged on two opposite surfaces of the carrier plate and is aligned with a center axis, and wherein the center axis is substantially parallel to the inner surface of the positioning bracket.

5. The image-capturing mechanism as claimed in claim 1, wherein a pair of resilient elements is compressible springs, the inner surface of the positioning bracket has a pair of first mounting portions, the carrier plate has a pair of second mounting portions, and wherein each resilient element has two ends respectively fixed on the first mounting portion and the second mounting portion.

6. The image-capturing mechanism as claimed in claim 1, wherein carrier plate has a cable opening, and the camera has a cable passing through the cable opening.

7. An electronic device having an image-capturing mechanism, said electronic device comprising:
a housing including a front casing and a rear casing mutually engaging with the front casing, wherein the front casing has a viewable hole arranged thereon;
a positioning bracket having a pivotable portion and a lens portion arranged on opposite surfaces of the positioning bracket, wherein the lens portion corresponds to the viewable hole;
a camera module including a carrier plate, a pivotable pin arranged on the carrier plate, and a camera arranged on the carrier plate, wherein the pivotable pin is pivotably coupled to the pivotable portion, and the camera corresponds to the lens portion;
at least one resilient element having two ends, wherein the two ends are respectively configured to correspond to the positioning bracket and the carrier plate; and
at least one adjustable element, the adjustable element having an end corresponding to the carrier plate for adjustment of the carrier plate, and an image-capturing angle of the camera module.

8. The electronic device as claimed in claim 7, further comprising:
a lighting unit having a circuit board fixed on the positioning bracket, and a plurality of light sources disposed on the circuit board and peripherally arranged about the camera, wherein the circuit board has a plurality of mounting holes arranged thereon, wherein the pivotable portion passes through the mounting hole, and the camera module is arranged in the mounting hole.

9. The electronic device as claimed in claim 8, wherein the front casing has a plurality of lighting holes peripherally arranged about the viewable hole, the positioning bracket has a plurality of translucent portions integrally formed by double injection molding, portions of the translucent portions are engaged to the lighting holes, wherein the light sources are respectively configured to correspond to the translucent portions, and the lens portion are integrally formed with the positioning bracket via double injection molding.

10. The electronic device as claimed in claim 7, wherein the pivotable pin is arranged on two opposite surfaces of the carrier plate and is aligned with a center axis, the center axis is substantially parallel to the inner surface of the positioning bracket, and wherein the center axis is parallel to a longitudinal direction of the housing.

11. The electronic device as claimed in claim 7, wherein a pair of resilient elements is compressible springs, the inner surface of the positioning bracket has a pair of first mounting portions, the carrier plate has a pair of second mounting portions, and wherein each resilient element has two ends respectively fixed on the first mounting portion and the second mounting portion.

12. The electronic device as claimed in claim 7, wherein carrier plate has a cable opening, and the camera has a cable passing through the cable opening.

13. The electronic device as claimed in claim 7, wherein a pair of adjustable elements each includes a head portion exposed from the rear casing and a free end abutting the carrier plate.
